(19) United States
(12) Patent Application Publication
(10) Pub. No.: US 2026/0038495 A1
(43) Pub. Date: Feb. 5, 2026

(54) INFERRING USER INTENT FOR ASSISTANCE USING A DISPLAY FREE BODY WEARABLE COMPUTING DEVICE

(71) Applicant: Dell Products L.P., Round Rock, TX (US)

(72) Inventors: SEUNGMI LEE, Singapore (SG); PRABU SELVARAJ, Singapore (SG); CHIN LEONG ONG, Singapore (SG); MICHIEL SEBASTIAAN EMANUEL PETRUS KNOPPERT, Amsterdam (NL); SI FI FAYE LI, Singapore (SG); YAN YAN, Singapore (SG); WEIYI WANG, Singapore (SG)

(21) Appl. No.: 18/788,774

(22) Filed: Jul. 30, 2024

(51) Int. Cl. G10L 15/22; G06F 1/16; G10L 15/08; G10L 15/18; G10L 15/26; G10L 25/78

(52) U.S. Cl. CPC G10L 15/22; G06F 1/163; G10L 15/1822; G10L 15/26; G10L 25/78; G10L 2015/088; G10L 2015/223

(57) ABSTRACT

Methods and systems for providing assistance to users of display free body wearable computing devices are disclosed. The method may include identifying that a user of a display free body wearable computing device is speaking. The method may also include inferring whether at least one other person is in a detection range of the user. In an instance where no other persons are inferred as being in the detection range, a large language model may be prompted using an intention analysis prompt and a transcription of the speaking by the user to obtain an assistance request outcome. The assistance request outcome may indicate that the speaking may include a question and/or command directed to the display free body wearable computing device. The display free body wearable computing device may subsequently provide computer-implemented services to the user based at least in part on the transcription of the speaking by the user.

### FIELD

Embodiments disclosed herein relate generally to providing assistance to users of display free body wearable computing devices. More particularly, embodiments disclosed herein relate to providing assistance to users of the display free body wearable computing devices by inferring a user intended target of a user of the users when the user is speaking.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a diagram illustrating a display free body wearable computing device in accordance with an embodiment.

FIGS. 1B-1D show diagrams illustrating alternative views of the display free body wearable computing device in accordance with an embodiment.

FIG. 2 shows a diagram illustrating a system in accordance with an embodiment.

FIG. 3 shows a flow diagram illustrating a method in accordance with an embodiment.

FIG. 4 shows a data flow diagram in accordance with an embodiment.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing assistance to a user using a display free body wearable computing device. The display free body wearable computing device may provide the assistance based on an assistance request spoken by the user.

The display free body wearable computing device may be configured to be worn on the user's head. When worn by the user, the display free body wearable computing device may provide computer-implemented services by interacting with the user.

The display free body wearable computing device may include any number and/or type of sensors (e.g., cameras, microphone arrays, etc.) that may obtain data relevant to speaking by the user. The data may include, for example, audio data of the speaking, images of other entities in range of the user, and/or any other data. At least a portion of the data may be used to infer whether at least one other person is in a detection range of the user.

If no other persons are inferred as being in a detection range (e.g., the user may not be speaking to the at least one other person), the display free body wearable computing device may obtain a transcription using audio data obtained from a first sensor (e.g., a microphone array positioned to capture the speaking of the user). Based on the transcription of the speaking, an intention analysis prompt issued to a large language model, the display free body wearable computing device may obtain an assistance request outcome.

The assistance request outcome may indicate that the speaking comprises a question and/or command directed to the display free body wearable computing device. Furthermore, the display free body wearable computing device may identify whether the question and/or command refers to an object present in a field of view of the user. If the question and/or command refers to an object present in the field of view of the user, the display free body wearable computing device may capture an image of the at least one object.

The display free body wearable computing device may perform a first action set using the image and the question and/or command to provide the computer-implemented services to the user. Alternatively, the display free body wearable computing device may perform a second action set using the question and/or command (e.g., if the question and/or command does not refer to an object present in the field of view of the user) to provide the computer-implemented services. An action set may include re-prompting the large language model to obtain an answer to the question and/or information usable to perform the command.

Thus, embodiments disclosed herein may provide an improved method for providing assistance to users of display free body wearable computing devices by inferring an intended target when the user is speaking. By doing so, a quality of computer-implemented services provided by a display free body wearable computing device of the display free body wearable computing devices may be improved.

In an embodiment, a method for providing assistance to users of display free body wearable computing devices is provided. The method may include: (i) identifying, using a first sensor of a display free body wearable computing device of the display free body wearable computing devices, that a user of the display free body wearable computing device is speaking; (ii) based on the identifying: (a) inferring, using at least a second sensor of the display free body wearable computing device, whether at least one other person is in a detection range of the first sensor; (b) in a first instance of the inferring where no other persons are inferred as being in the detection range of the first sensor: (i) obtaining an assistance request outcome based on a transcription of the speaking by the user, an intention analysis prompt, and a large language model; and (ii) a first instance of the obtaining where the assistance request outcome indicates that the speaking is directed to the display free body wearable computing device: (a) providing, by the display free body wearable computing device, computer-implemented services that are based, at least in part, on the transcription.

Identifying that the user of the display free body wearable computing device is speaking may include: (i) obtaining audio data using the first sensor, the first sensor being an audio sensor positioned to capture the speaking; and (ii) identifying that the audio data comprises the speaking by the user.

Inferring whether the at least one other person is in the detection range of the first sensor may include: (i) identifying, using at least one image sensor of the display free body wearable computing device, whether the at least one other person is present in a field of view of the at least one image sensor; and (ii) identifying, using at least two audio sensors of the display free body wearable computing device, whether the at least one other person is present within a distance threshold relative to the user.

The at least two audio sensors may include at least one audio sensor adapted to capture audio data from a direction behind the user's back while the user wears the display free body wearable computing device.

Obtaining the assistance request outcome may include: prompting, using the prompt, the large language model to identify, in the transcription, a user intended target of the speaking.

Prompting the large language model may include: (i) inferring, using the large language model and the prompt, whether the speaking comprises a question and/or command directed by the user to the display free body wearable computing device, (ii) wherein obtaining the assistance request outcome further may include: (a) in a first instance of the inferring where the user intent includes a question and/or command directed to the display free body wearable computing device: (i) generating the assistance request outcome to indicate that that the speaking indicates that the display free body wearable computing device is being queried by the user for assistance.

Providing the computer-implemented services may include: (i) identifying whether the question and/or command refers to at least one object present in a field of view of the user; (ii) in a first instance of the identifying where the question and/or command refers to the at least one object present in the field of view of the user: (a) capturing, using at least one image sensor of the display free body wearable computing device, an image of the at least one object; and (b) performing, by the display free body wearable computing device and using the image and the question and/or command, a first action set to provide the computer-implemented services; (iii) in a second instance of the identifying where the question and/or command does not refer to the at least one object present in the field of view of the user: (a) performing, by the display free body wearable computing device and using the question and/or command, a second action set to provide the computer-implemented services.

Performing the first action set may include: re-prompting the large language model to obtain an answer to the question and/or information usable to perform the command.

The method may further include: in a second instance of the inferring where the at least one person is inferred as being in the detection range of the first sensor: (i) analyzing the speaking by the user using a schema, the schema including: (a) trigger phrases associated with corresponding functionalities of the display free body wearable computing device; and (ii) in an instance of the analyzing where at least one of the trigger phrases are identified in the speaking: (a) performing a portion of the functionalities corresponding to the at least one of the trigger phrases to provide the computer-implemented services.

The display free body wearable computing device may include: (i) an integrated sensing and interaction component adapted to: (a) be positioned symmetrically on two portions of a user's head, (b) be positioned between ears and eyes of the user, and (c) capture a stereo image of at least a portion of a scene present in a field of view of the user; (ii) an integrated computing, powering, and securing portion; and (iii) an adjustment member adapted to position the integrated sensing and interaction component with respect to the integrated computing, powering, and securing portion.

The integrated sensing and interaction component may include: (i) a pair of cameras; (ii) speakers; (iii) a microphone array; and (iv) a touch pad.

The integrated computing, power, and securing portion may include: (i) a data processing system; (ii) a battery; (iii) a microphone array; and (iv) a curved headband.

The integrated computing, powering, and securing portion may be adapted to: (i) obtain an audio input from the integrated sensing and interaction component; (ii) perform, by the data processing system, a speech recognition action set, based on the audio input, to obtain a speech recognition result; (iii) obtain a portion of data from a remote entity, the data being based at least in part on the speech recognition result; and (iv) use the portion of the data to assist in an interaction that the user is involved in.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

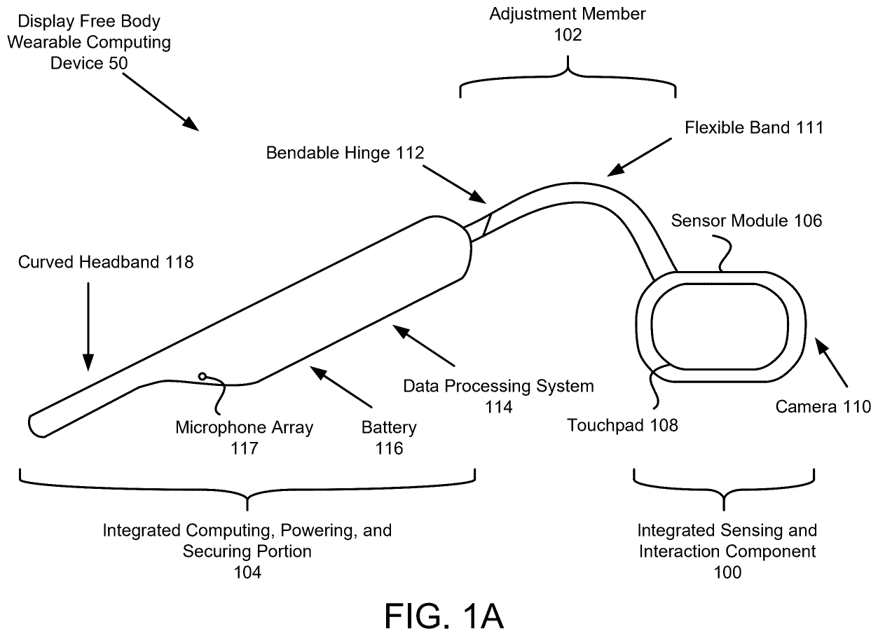

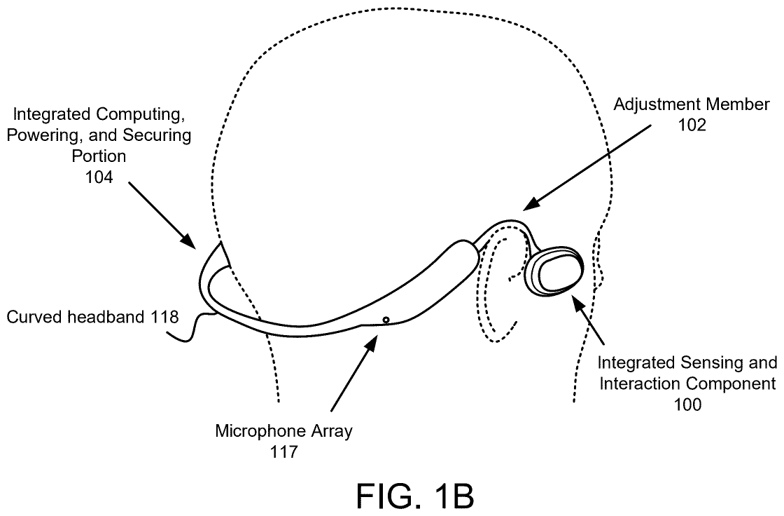

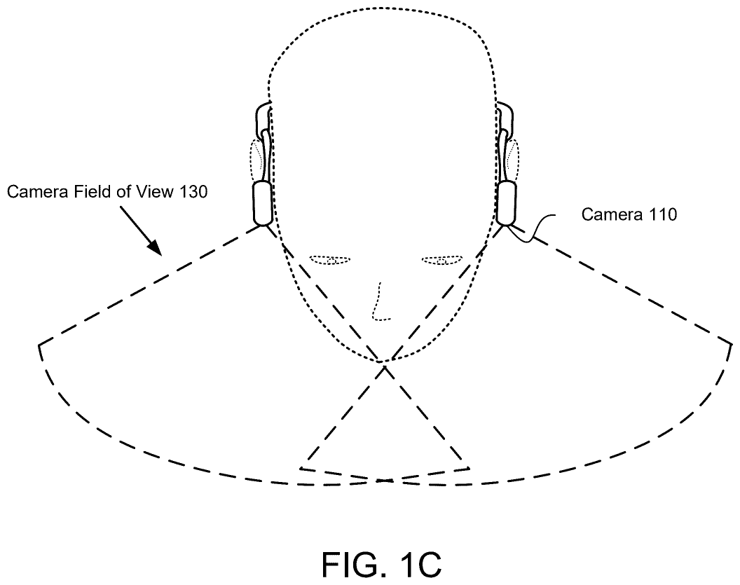

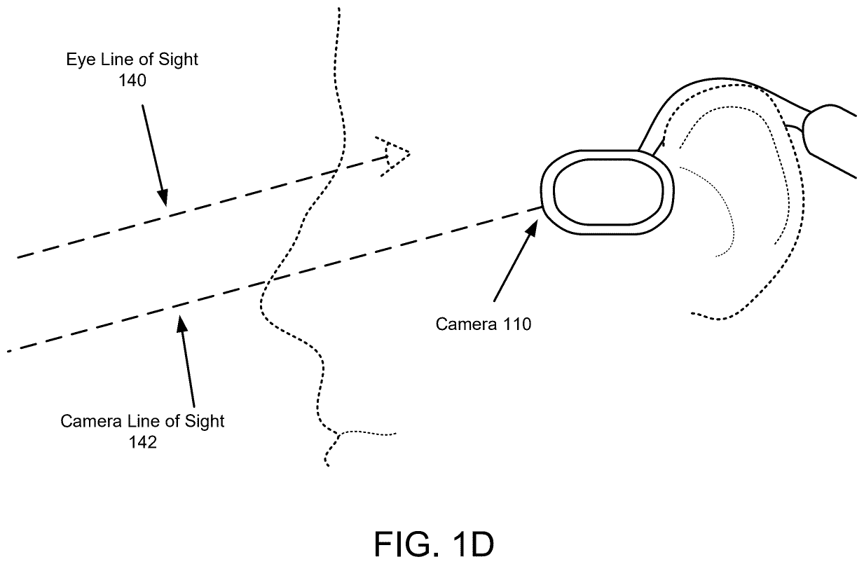

Turning to FIG. 1A, various types of computing devices may provide computer implemented services. The various types of computing devices may include, for example, desktop computers, laptop computers, cell phones, and/or other types of computing devices.

Such computing devices may provide any number and types of computer-implemented services (e.g., to a user of the computing device and/or devices operably connected to the computing device). The computer-implemented services may include, for example, data acquisition services, communication services, and/or other types of services that may be relevant to user and/or other devices.

However, the ability to provide such services may be limited based on the information available to the computing devices. For example, a desktop computer may be positioned under a desk, or in other locations. Consequently, the desktop computer may have a very limited capability to gather information regarding the environment in which it resides.

Accordingly, due to the limited information, the types and quality of computer implemented services may be limited. Returning to the desktop computer example, such desktop computers may lack native ability to capture images and/or audio of scenes that are relevant to a user of the desktop computer. Thus, the desktop computer may lack the ability to provide some types of services that are relevant to a user.

In general, embodiments disclosed herein relate to systems, methods, and devices for providing computer implemented services that are of relevance to users. To provide the computer implemented services, a display free body wearable computing device may be utilized. For example, display free body wearable computing device 50 may be adapted to be worn by a user. When worn by a user, the body wearable computing device may be able to gather information that is more relevant to users for use in providing computer-implemented services.

The computer-implemented services may include, for example, providing assistance to a user of the display free body wearable computing device based on speaking by the user. To provide the assistance to the user, the display free body wearable computing device may obtain, using at least one audio sensor of the display free body wearable computing device, audio data and identify that the user is speaking based on the audio data.

Once identified, the display free body wearable computing device may infer a user intended target of the speaking. To do so, the display free body wearable computing device may infer whether at least one other person is in a detection range of the user (e.g., using sensor data, image data, etc.). If at least one other person is inferred to be in the detection range, display free body wearable computing device may analyze the speaking by the user according to a schema (e.g., a set of trigger phrases corresponding to functionalities of the display free body wearable computing device). However, if no other persons are inferred to be in the detection range, display free body wearable computing device may obtain an assistance request outcome to infer a user intent of the speaking by the user.

The assistance request outcome may be obtained by prompting a large language model using at least a transcription of the speaking, and an intention analysis prompt. The large language model may generate the assistance request outcome that may indicate whether the speaking by the user comprises a question and/or command directed by the user to the display free body wearable computing device. For example, consider a scenario in which a user verbally issues a question (e.g., “How do I brew coffee using a French press?”). Based the intention analysis prompt and/or information regarding the situation in which the user is involved (e.g., no other persons present around the user), the assistance request outcome may indicate that the question is directed to the display free body wearable computing device.

If the assistance request outcome indicates that the question and/or command is directed to display free body wearable computing device, assistance may be provided to the user based on a transcription of the speaking. For example, returning to the example in which the user verbally issues the question (“e.g., “How do I brew coffee using a French press?”), the transcription of the question may be used to re-prompt the large language model to obtain an answer to the question (e.g., a step-by-step tutorial communicated to the user via speakers of the display free body wearable computing device).

Therefore, through use of this more relevant information, the display free body wearable computing device may be more likely to provide computer-implemented services that are of higher relevancy and/or improved quality to users.

To provide the computer-implemented services to the user of body wearable computing device 50, display free body wearable computing device 50 may include: (i) integrated sensing and interaction component 100, (ii) adjustment member 102, and (iii) integrated computing, powering, and securing portion 104. Each of these components is discussed below.

Integrated sensing and interaction component 100 may provide input/output services to the user. To do so, integrated sensing and interaction component 100 may host sensors module 106, touchpad 108, camera 110, and/or any other components. To host the components, integrated sensing and interaction component 100 may include a pair of enclosures (e.g., 3-dimensional bubble-shaped housings that may be at least partially transparent) adapted to be positioned symmetrically on both sides of the user's head, between ears and eyes of the user (e.g., proximate to temples of the user). When worn, integrated sensing and interaction component 100 may operate, for example, without covering the user's ear and extending past the user's eyes. By being positioned as such, the body wearable computing device may be worn and used to interact with the user without obstructing facial features (e.g., eyes, ears, etc.) of the user.

Integrated sensing and interaction component 100 may obtain inputs from any number of sensors to identify actions to be performed. For example, integrated sensing and interaction component 100 may obtain guidance image using camera 110 and at least partially process the guidance image to obtain an image processing result. The guidance image may depict a portion of the scene and a portion of the user (e.g., one or more of the user's hands) of display free body wearable computing device 50. Integrated sensing and interaction component 100 may identify a recognizable gesture (e.g., a pointing gesture, framing gesture, etc.) from the guidance image that may trigger an action set for capturing an image. Integrated sensing and interaction component 100 may also obtain and use audio inputs (e.g., voice commands) for use in identifying actions sets for capturing an image, individually and/or cooperatively with visual inputs (e.g., the guidance image).

For example, consider a scenario in which a user raises a hand to point at car while issuing a voice command to take a picture. Integrated sensing and interaction component 100 may identify the user's hand as a pointing gesture and/or identify the voice command issued by the user. Integrated sensing and interaction component 100 and/or any other entities (e.g., data processing system 114, remote entities, etc.) may subsequently identify an action set based on the gesture and/or the voice command. The action set may include, for example, audio instructions using speakers of integrated sensing and interaction component 100 to direct the user to remove the user's hand from a field of view while retaining the car in the field of view, activating image sensors of camera 110 to capture a stereo image, combining the stereo image, and/or any other actions.

Touchpad 108 may be used to receive tactile input. For example, a user may provide input by using one or more fingers to touch, press, any/or perform any other actions using touchpad 108. The input may be used, for example, to trigger actions, provide information to the display free body wearable computing device for use in providing computer-implemented services, and/or any other use cases. To improve ease of use, touchpad 108 may be affixed to a lateral side of integrated sensing and interaction component 100 away from the user's head when worn. Touchpad 108 may be included on either or both enclosures of integrated sensing and interaction component 100.

Sensor module 106 may provide at least a portion of the input/output services provided by integrated sensing and interaction component 100. To do so, sensors module 106 may include any number and/or type of sensors. For example, sensors module 106 may include speakers and a microphone array. The microphone array of sensor module 106 may be positioned to capture speaking by the user and may subsequently obtain, for example, audio data that may indicate a speaking by the user. The audio data may be analyzed by components of sensor module 106, data processing system 114, and/or any other entities to infer a user intended target of the speaking and/or identify questions and/or commands directed to display free body wearable computing device 50 based on the speaking. The speakers of sensor module 106 may be used to communicate supplementary information to the user (e.g., relevant to questions and/or commands spoken by the user).

Camera 110 may capture images. The images captured by camera 110 may include stereo images of at least a portion of a scene present in a field of view of the user. The stereo images may include a pair of images of the scene, each of the images being captured at different angle and/or positions (e.g., different viewpoints) with respect to the scene by camera 110. For example, camera 110 may capture images of one or more other people that may be in a detection range of the user (e.g., that the user may be speaking to), objects present in the scene that the user may be referring to when speaking, and/or any other information.

To do so, camera 110 may include a pair of cameras that may each be positioned inside an enclosure of the pair of enclosures of integrated sensing and interaction component 100 on both sides of the user's head between eyes and ears of the user. Furthermore, camera 110 may be pointed in a direction generally aligned with a direction that the user's eyes may be pointed. By being positioned as such, camera 110 may be configured to establish a camera line of sight that is parallel to a line of sight of the user, and a camera field of view that include the field of view of the user. Refer to FIGS. 1C-1D for additional details regarding the camera field of view and the camera line of sight relative to the user.

Camera 110 may configure image capturing settings (e.g., focus, zoom, etc.) based on information obtained by integrated sensing and interaction component 100 and/or any other components of display free body wearable computing device 50 (e.g., data processing system 114).

Adjustment member 102 may at least partially secure display free body wearable computing device 50 to the user's head and be adapted to position integrated sensing and interaction component 100 with respect to integrated computing, powering, and securing portion 104. To do so, adjustment member may include flexible band 111 and bendable hinge 112.

Flexible band 111 may be configured in a shape (e.g., a curved shape) that may enable adjustment member 102 to rest on an ear of the user while display free body wearable computing device 50 is used by the user. Furthermore, flexible band 111 (e.g., the shape of flexible band 111) may be modified (e.g., via bending) to improve comfort and/or fit of display free body wearable computing device 50 while used by the user.

Bendable hinge 112 may enable repositioning of integrated sensing and interaction component 100 with respect to integrated computing, powering, and securing portion 104. For example, when bendable hinge 112 is in a first state (e.g., not bent), integrated computing, powering, and securing portion 104 may be configured to be positioned around the back of the user's head while integrated sensing and interaction component 100 is positioned between ears and eyes of the user. Alternatively, when bendable hinge 112 is in a second state (e.g., bent at a certain angle), integrated computing, powering, and securing portion 104 may be configured to be positioned around the top of the user's head while integrated sensing and interaction component 100 is positioned between ears and eyes of the user.

Integrated computing, power, and securing portion 104 may provide at least a portion of the computer-implemented services and may at least partially secure display free body wearable computing device 50 to the user. To do so, integrated computing, powering, and securing portion 104 may include an enclosure that includes: (i) data processing system 114, (ii) battery 116, (iii) microphone array 117, and (iv) curved headband 118.

Data processing system 114 may provide computer-implemented services based on inputs (e.g., stereo images, audio inputs, etc.) obtained from integrated sensing and interaction component 100. To do so, data processing system 114 may host any quantity of hardware resources that may include, for example, a processor operably coupled to memory, storage, and/or other hardware components (e.g., sensors of integrated sensing and interaction component 100). Data processing system 114 may facilitate performance of actions requested by a user of display free body wearable computing device 50 (e.g., independently and/or cooperatively with remote entities that may provide a second portion of computer-implemented services).

Using the hosted hardware resources and/or applications supported by the hardware resources, data processing system 114 may provide services relevant to images, audio, text, decision making, and/or any other capabilities. For example, data processing system 114 may perform operations relevant to the service and/or data processing system 114 may communicate with remote entities using a network stack hosted by hardware resources of data processing system 114.

To provide services relevant to images (e.g., pictures, video, etc.), data processing system 114 may obtain image data from one or more cameras of camera 110. The image data may be used to identify user inputs (e.g., hand gestures) that may indicate requests for actions to be performed by the body wearable computing device. Data processing system 114 may subsequently make decisions to handle the requests based on the user input. Additionally, data processing system 114 may perform image stitching using a stereo image of the image data to obtain a unified image of a portion of a scene present in a field of view of the user. Data processing system 114 may process and/or perform actions based on derived information from the unified image.

To handle the requests based on the user inputs for decision making, data processing system 114 may utilize hardware and/or software adapted to process the user inputs. For example, data processing system 114 may use a tactile input handling application to make decisions (e.g., perform an action set, communicate information, etc.) based on tactile input received from touchpad 108.

Additionally, data processing system 114 may perform services based on audio input received from a microphone array of sensor module 106 that may include, for example, transcription, speaker segmentation, and/or any other service. To do so, data processing system 114 may, for example, host applications adapted to interpret conversations, recognize speech, convert speech to text, and/or perform any other operations. Data processing system 114 may similarly make decisions based on information obtained from the audio input.

To communicate results of the services to the user of the body wearable computing device, data processing system 114 may send information to be output from speakers of sensor module 106. To do so, data processing system 114 may utilize hardware and/or software to transmit the information to the speakers. For example, an application may convert text results obtained from the audio and/or image services, as discussed above, to an audio output format that may be communicated to the user.

Consider a scenario in which the user speaks a command that may, for example, indicate a request for additional information regarding a sign with words written in a certain language. Data processing system 114 and/or integrated sensing and interaction component 100 may infer from a transcription of the speaking that the speaking includes a command for display free body wearable computing device 50 to translate and/or dictate a phrase written on the sign. Data processing system 114 may subsequently communicate the image and/or information from the image to any number and/or type of remote entities (e.g., cloud services, remote artificial intelligence platforms, etc.) that may provide additional services that may provide requested information/results to data processing system 114. Data processing system 114 may then provide instructions to integrated sensing and interaction component 100 to dictate (e.g., using speakers) the requested information.

Battery 116 may supply electrical power to data processing system 114, components of integrated sensing and interaction component 100, and/or any other entities. To do so, battery 116 may obtain and/or store electrical power provisioned by an external power source. The electrical power may subsequently be provided to components of display free body wearable computing device 50 that may request the electrical power for operation.

Microphone array 117 may be positioned to capture audio data from a direction behind the user's back while the user wears display free body wearable computing device 50. The audio data may be used, for example, to infer a presence of one or more other persons in a detection range of microphone array 117, distinguish speaking by the user from other environmental sounds, and/or any other applications.

Curved headband 118 may connect two portions of the body wearable computing device. For example, curved headband may be configured in a curved shape and be adapted to connect a first side of display free body wearable computing device 50 (e.g., including a first portion of integrated sensing and interaction component 100, adjustment member 102, etc.) that may be positioned on the first side of the user's head to a second side of display free body wearable computing device 50 that may be positioned on the second side of the user's head.

While illustrated in FIG. 1A with a limited number of specific components, a system may include additional, fewer, and/or different components without departing from embodiments disclosed herein.

Thus, as shown in FIG. 1A, display free body wearable computing device 50 may provide computer-implemented services to a user using components adapted to capture images of a portion of a scene desired by the user.

Turning to FIG. 1B, an alternate view of display free body wearable computing device 50 in accordance with an embodiment is shown.

In FIG. 1B, display free body wearable computing device 50 may be illustrated while worn by a user (drawn in short-dashed outline). As shown in FIG. 1B, a portion of integrated sensing and interaction component 100 of display free body wearable computing device 50 is positioned on a first side of the user's head between an eye and an ear of the user while a portion of adjustment member 102 rests on the ear of the user. While not shown, it may be appreciated that a second portion of integrated sensing and interaction component 100 and a second portion of adjustment member 102 may be similarly positioned on a second side of the user's head.

Integrated computing, powering, and securing portion 104 and curved headband 118 of integrated computing, powering, and securing portion 104 may connect the first portions and second portions of adjustment member 102 and integrated sensing and interaction component 100. To do so, curved headband 118 may wrap around the back of the user's head, as shown, while adjustment member 102 is in a first configuration (e.g., not bent). While not shown, it may be appreciated that curved headband 118 and integrated computing, powering, and securing portion 104 may be positioned around the top of the user's head and/or any other position when adjustment member 102 is in a second configuration.

Turning to FIG. 1C, a second alternate view of display free body wearable computing device 50 in accordance with an embodiment is shown. The second alternate view of display free body wearable computing device 50 may include a top-down view of display free body wearable computing device 50 while worn by a user (drawn in short-dashed outline) and may illustrate a camera field of view established by camera 110 (drawn in long-dashed outline).

Camera 110 of integrated sensing and interaction component 100 may, as discussed above, include a pair of cameras positioned on both sides of the user's head between eyes and ears of the user and may be pointed in a direction generally aligned with a direction that the user is facing. Each camera of the pair of cameras may include lens and a sensor that may be configured to establish a portion of camera field of view 130. Camera field of view 130 may include an angular measurement that may indicate a viewable area that may be captured by the camera.

Camera field of view 130 may be established based on the lens (e.g., a focal length of the lens) and/or the sensor (e.g., a size of the sensor) of camera 110. Each camera of the pair of cameras of camera 110 may establish a portion of camera field of view 130 that may each capture a portion of a scene at different angles and/or positions with respect to the scene by the pair of cameras.

For example, consider a scenario in which camera field of view 130 is configured by camera 110 to be 120 degrees of horizontal view. Each camera of the pair of cameras of display free body wearable computing device 50 may capture an image based on the 120 degrees of the scene present in a field of view of the user. When aggregated (e.g., used together), a field of view of the images exceed a field of field of the user. The field of view of the user may include, for example, 120 degrees of viewable area based on binocular vision (e.g., a single image perceived from a pair of images view by a pair of eyes) of the user. The pair of cameras of camera 110 may similarly capture a stereo image that may include a pair of images of the portion of the scene present in the field of view of the user at the different angles and/or positions.

The stereo image may be processed (e.g., via image stitching, aggregation, etc.) by integrated sensing and interaction component 100, data processing system 114, and/or any other entities to generate a resulting image that may include at least the portion of the scene present in the field of view of the user (e.g., a greater field of view when compared to the user's field of view based on the user's binocular vision). The resulting image may subsequently provide information (e.g., additional information that the user may not obtain based on a field of view of the user's eyes) relevant to providing computer-implemented services to the user.

Thus, as shown in FIG. 1C, camera 110 of display free body wearable computing device 50 may be adapted to capture images of at least a portion of the scene present in a user's field of view. The images may provide visual information usable to perform desired actions by display free body wearable computing device 50 for the user.

Turning to FIG. 1D, a third alternate view of display free body wearable computing device 50 in accordance with an embodiment is shown. The third alternate view of display free body wearable computing device 50 may include a side view of display free body wearable computing device 50 while worn by a user and may illustrate a camera line of sight established by camera 110.

Camera 110 may, as discussed above, include a pair of cameras positioned on both sides of the user's head between eyes and ears of the user and may be pointed in a direction generally aligned with a direction that the user is facing. Each camera of the pair of cameras may include lens and a sensor that may be configured to establish camera line of sight 142 that may be parallel to eye line of sight 140 of the user.

Camera line of sight 142 may enable camera 110 to capture images based on a vertical field of view that may be generally aligned with a vertical field of view of the user's eyes. The vertical field of view may be established, for example, by configuring cameras 110 (e.g., in a portrait orientation) to capture a vertical field of view that may include a vertical field of view of the user's eyes. By doing so, camera 110 may capture images of arm/hand movements and/or gestures when performed by the user.

Thus, as shown in FIG. 1D, cameras of display free body wearable computing device 50 may be adapted to capture images that may enable a user to interact with display free body wearable computing device 50 based on the user's line of sight.

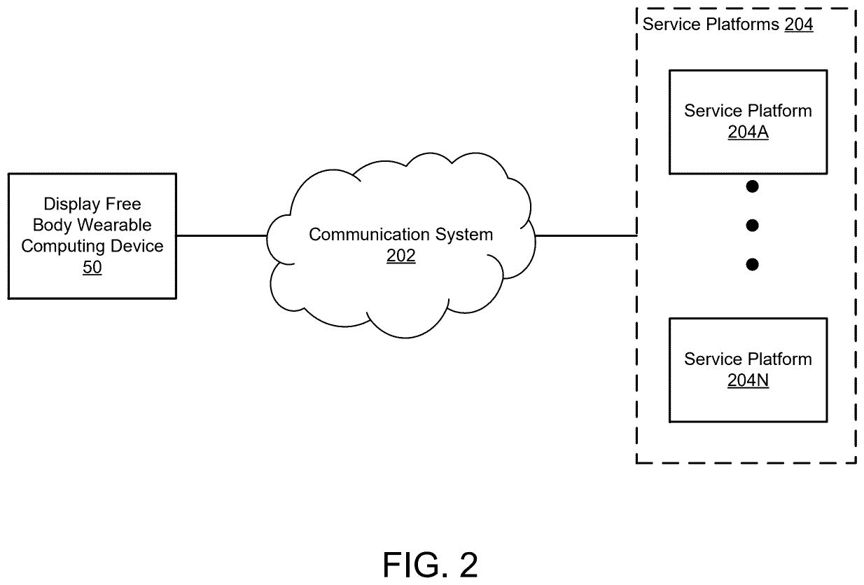

Turning to FIG. 2, a block diagram in accordance with an embodiment is shown. The block diagram may illustrate a system used in providing computing-implemented services by the display free body wearable computing device.

Display free body wearable computing device 50 may, as previously discussed, provide computer-implemented services to a user. While providing the computer-implemented services, display free body wearable computing device 50 may interact with service platforms 204 to obtain information relevant to the computer-implemented services provided to the user.

Service platforms 204 may, as discussed above, provide remote computing services. Service platforms 204 may include any number and/or type of service platforms that may individually and/or cooperatively perform services requested by display free body wearable computing device 50. Service platforms 204 may include, for example, cloud services (e.g., image storage, speech-to-text, large language model, etc.), artificial intelligence platforms (e.g., generative artificial intelligence), and/or any other remote service platforms. Service platforms 204 may provide information based at least in part on input obtained from display free body wearable computing device 50.

For example, consider a scenario in which a user, while wearing display free body wearable computing device 50, may be looking at a bird perched on a tree in a forest. Display free body wearable computing device 50 may obtain a request (e.g., via a voice command captured by a microphone array of display free body wearable computing device 50, a gesture captured by cameras of from display free body wearable computing device 50, etc.) from the user indicating a desire for a picture of the bird. Display free body wearable computing device 50 may: (i) obtain data that may include an image of the scene, (ii) pre-process the data (e.g., focus the image on the bird, stitch images from a plurality of images captured by cameras of display free body wearable computing device 50, etc.) to obtain a unified image, (iii) communicate the unified image to a service platform (e.g., 204A) of service platforms 204, and/or perform any other actions. Service platform 204A may perform, for example, object recognition services, information search services, and/or any other services to capture the desired image based on the unified image provided by display free body wearable computing device 50. Service platform 204A and/or a second service platform (e.g., service platform 204B) may store the desired image in an image storage service for subsequent retrieval by a user of display free body wearable computing device 50.

Consider a second scenario in which a user of display free body wearable computing device 50 desires to generate a three-dimensional (3D) interactive model of a room that the user is present. Once a request for the 3D interactive model is identified, body wearable computing device 50 may: (i) provide instruction to the user (e.g., to move around the room), (ii) capture images using the camera at a certain frequency (e.g., while the user is moving around the room), and/or perform any other actions. Display free body wearable computing device 50 may provide the captured images along with metadata regarding each of the captured images to a second service platform (e.g., 204B) of service platforms 204. Using image data provided by display free body wearable computing device 50, service platform 204B may perform, for example, 3D rendering services, video editing services, video storage services, and/or any other services to generate the video desired by the user. Display free body wearable computing device 50 may subsequently communicate a status (e.g., completion, instructions for access, etc.) of the desired 3D interactive model to the user.

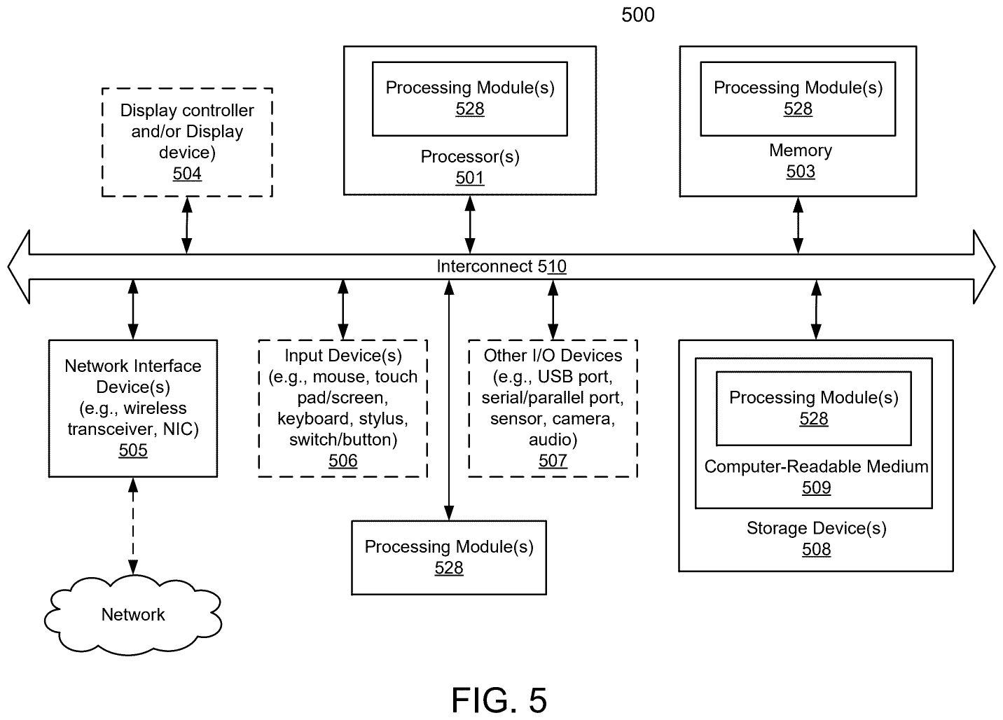

Communication system 202 may allow any of body wearable computing device 50 and service platforms 204 to communicate with one another (and/or with other devices not illustrated in FIG. 2). To provide its functionality, communication system 202 may be implemented with one or more wired and/or wireless networks. Any of these networks may be a private network (e.g., the “Network” shown in FIG. 5), a public network, a virtual network (e.g., a virtual private network), and/or may include the Internet. For example, body wearable computing device 50 may be operably connected to service platforms 204 via the Internet, a private network, etc. Body wearable computing device 50 and service platforms 204 may be adapted to perform one or more protocols for communicating via communication system 202.

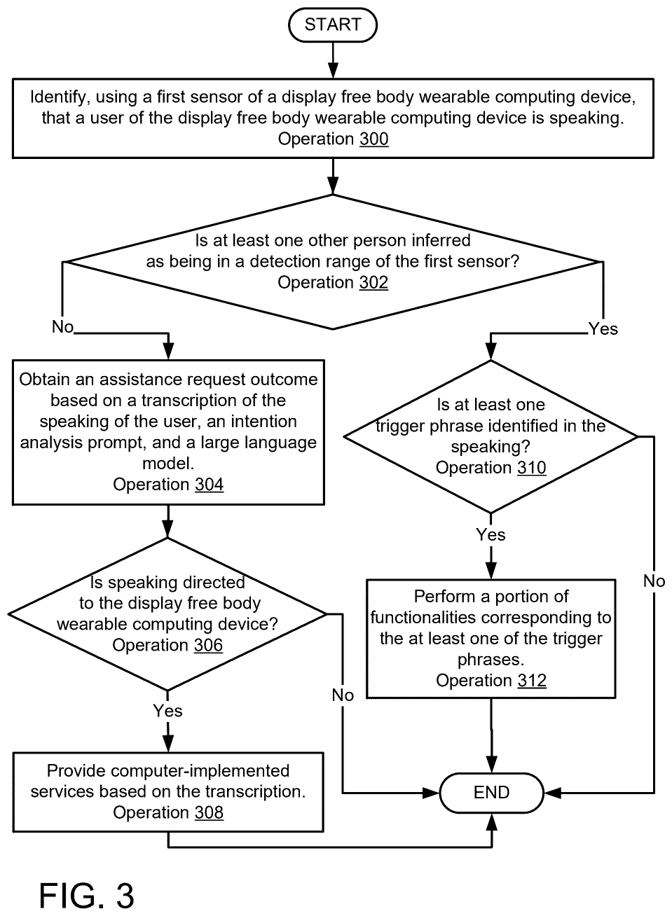

As discussed above, the components of FIGS. 1A-2 may perform various methods to provide assistance to a user of a display free body wearable computing device. FIG. 3 illustrates a method that may be performed by the components of the systems of FIGS. 1A-2. In the diagrams discussed below and shown in FIG. 3, any of the operations may be repeated, performed in different orders, and/or performed in parallel with or in a partially overlapping in time manner with other operations.

Turning to FIG. 3, a first flow diagram illustrating a method of providing assistance to a user of the display free body wearable computing device in accordance with an embodiment is shown. The method may be performed, for example, by any of the components of the systems of FIG. 1A-2, and/or other components not shown therein.

At operation 300, it may be identified, using a first sensor of display free body wearable computing device 50, that the user is speaking. It may be identified that the user is speaking by: (i) recording audio data of audio signals present in an environment that the user is present, (ii) identifying that the audio data includes speaking by the user (e.g., based on patterns of the audio signals matching historic audio signals of speaking by the user), (iii) processing the audio data to identify speech, and/or any other processes.

At operation 302, an inference may be made regarding whether at least one other person is in a detection range of the first sensor. The inference may be made by: (i) capturing, using at least one image sensor of display free body wearable computing device 50, an image of a portion of a scene present in a field of view of the user, (ii) obtaining, using at least two audio sensors (e.g., at least one microphone array positioned to capture audio data from a direction behind the user's back while the user wears display free body wearable computing device 50 and/or at least one microphone array positioned to capture audio data from a direction in front of the user while the user wears display free body wearable computing device 50), (iii) processing the image and/or audio data to identify a presence of the at least one other person within a detection range and/or a distance of the at least one other person relative to the user, (iv) comparing the distance of the at least one other person to a distance threshold, and/or any other processes. If it is inferred that at least one other person is in the detection range (e.g., the inference is “Yes” at operation 302), the method may proceed to operation 310. If it is inferred that no other persons are in the detection range (e.g., the inference is “No” at operation 302), the method may proceed to operation 304.

At operation 304, an assistance request outcome may be obtained based on a transcription of the speaking by the user, an intention analysis prompt, and a large language model. The assistance request outcome may be obtained by: (i) obtaining an intention analysis prompt (e.g., that may indicate a request to obtain information regarding an intent of a transcription) based on an intention analysis prompt template, (ii) prompting a large language model (e.g., a generative artificial intelligence model) using the intention analysis prompt and at least a portion of the transcription, (iii) obtaining a result generated by the large language model that may indicate whether the speaking includes a question and/or command directed by the user to display free body wearable computing device 50, and/or performing any other actions.

At operation 306, an inference may be made regarding whether the assistance request outcome indicates that the speaking is directed to the display free body wearable computing device. The inference may be made by: (i) identifying, based on the assistance request outcome, whether the speaking includes a question and/or command directed to display free body wearable computing device 50, (ii) comparing a result (e.g., a confidence level) of the assistance request outcome to a confidence level threshold, and/or performing any other actions. If the assistance request outcome is inferred to indicate that the speaking is directed to display free body wearable computing device 50 (e.g., the inference is “Yes” at operation 306), the method may proceed to operation 308. If the assistance request outcome is inferred to indicate that the speaking is not directed to display free body wearable computing device 50 (e.g., the inference is “No” at operation 306), the method may end following operation 306.

At operation 308, computer-implemented services may be provided based on the transcription. The computer-implemented services may be provided by: (i) identifying whether the transcription refers to at least one object present in a field of view of the user, (ii) capturing an image of the at least one object, (iii) re-prompting the large language model using the question and/or command and the image (e.g., if the transcription refers to the at least one image), (iii) obtaining an answer to the question and/or information usable to perform the command, (iv) communicating the answer to the user (e.g., using speakers of display free body wearable computing device 50), and/or performing any other actions.

The method may end following operation 308.

Returning to operation 302, the method may proceed to operation 310 if the at least one other person is inferred to be in the detection range.

At operation 310 a determination may be made regarding whether at least one trigger phrase is identified in the speaking. The determination may be made by: (i) analyzing the speaking by the user using a schema that may include trigger phrases (e.g., a wake word, an identifying name of display free body wearable computing device 50, predetermined commands to capture images/audio, etc.), (ii) matching the trigger phrase to corresponding functionalities of display free body wearable computing device 50, and/or any other processes. If the at least one trigger phrase is identified in the speaking (e.g., the determination is “Yes” at operation 310), the method may proceed to operation 312. If the at least one trigger phrase is not identified in the speaking (e.g., the determination is “No” at operation 310), the method may end following operation 310.

At operation 312, a portion of functionalities may be performed corresponding to the at least one of the trigger phrases. The portion of functionalities may be performed by: (i) identifying an action set corresponding to the at least one trigger phrase, (ii) performing the action set, (ii) communicating information (e.g., regarding a status of the performing of the action set, a response to relevant to the trigger phrase, etc.) to the user, and/or performing any other actions.

The method may end following operation 312.

Using the method shown in FIG. 3, assistance may be provided to a user of display body wearable computing device 50 by inferring a user indented target, question, and/or command based on speaking by the user. By doing so, a quality and/or relevance of computer-implemented services provided to the user while using display free body wearable computing device 50 may be improved.

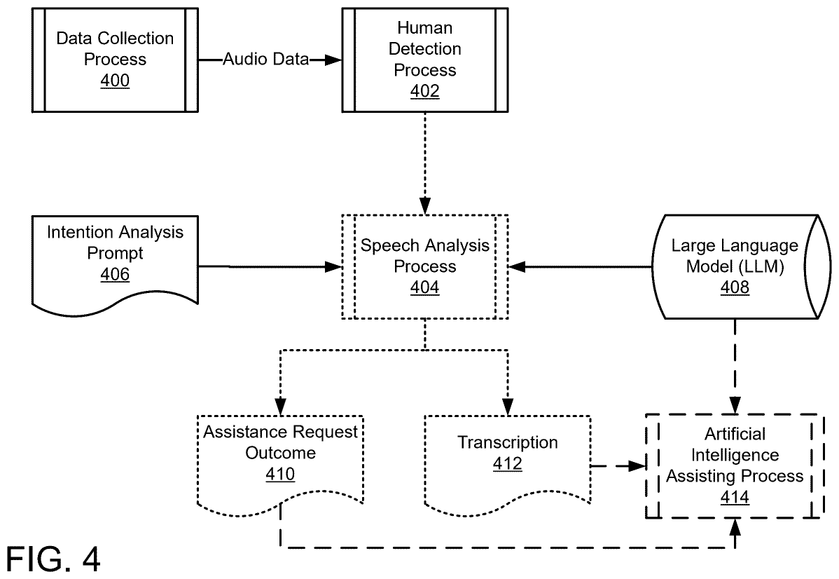

To further clarify embodiments disclosed herein, a data flow diagram in accordance with an embodiment is shown in FIG. 4. In this diagram, flows of data and processing of data are illustrated using different sets of shapes. A first set of shapes (e.g., 406, 410, etc.) is used to represent data structures, a second set of shapes (e.g., 400, 402, etc.) is used to represent processes performed using and/or that generate data, and a third set of shapes (e.g., 408) is used to represent large scale data structures such as databases.

Turning to FIG. 4, a data flow diagram in accordance with an embodiment is shown. The data flow diagram may illustrate data used in and data processing performed in providing assistance to a user of a display free body wearable computing device.

To provide the assistance to the user of the display free body wearable computing device, data collection process 400 may be performed. During data collection process 400, speaking by the user may be identified. To identify that the user is speaking, audio data may be collected by at least one sensor (e.g., a microphone array of integrated sensing and interaction component 100) of display free body wearable computing device 50. The audio data may be processed to identify features (e.g., phonemes, frequencies, words, etc.) of speech, for example, by performing frequency isolation and/or word analysis, utilizing speech-to-text applications (e.g., automatic speech recognition), and/or performing any other actions. Once identified that the user is speaking, it may be inferred whether at least one other person is present in a detection range of a scene in which the user is speaking (e.g., that the user may be speaking to).

To infer whether the at least one other person is in a detection range, human detection process 402 may be performed. During human detection process 402, information may be obtained from any number and/or types of sensors, and an inference may be made regarding whether at least one other person is in the detection range based on the information. To obtain the information, a detection range (e.g., a 2 meter radius from all directions around the user) may be identified. Using the detection range as a scope, display free body wearable computing device 50 may capture an image (e.g., using camera 110), process the image (e.g., using object recognition) to identify a presence of the at least one other person within the detection range, and/or perform any other actions. Additionally, any number and/or types of audio sensors (e.g., microphone arrays of integrated sensing and interaction component 100, microphone array 117 of integrated computing, power, and securing portion 104, etc.) may obtain audio data, motion sensors (e.g., time of flight sensors) may identify distances of sources of sound in the audio data (e.g., by performing triangulation processes), display free body wearable computing device 50 may process the audio data and the distances to identify whether the at least one other person is within the detection range.

If the at least one other person is identified, display free body wearable computing device 50 may, for example, infer that the speaking may be directed to the at least one other person. Consider a scenario in which a user, while wearing display free body wearable computing device 50, verbally issues a question related to how to change a tire. If another person is within the detection range (e.g., 2 meters) of the user, it may be inferred that the user is speaking to the other person. However, if no other person is within the detection range (e.g., the user is alone in the scenario), display free body wearable computing device 50 may infer that the user is not speaking to another person. Based on the inference, display free body wearable computing device 50 may analyze the speaking by the user to obtain information regarding user intent of the speaking.

To obtain the information regarding user intent of the speaking, speech analysis process 404 may be performed. Speech analysis process 404 (shown in short-dashed lines) may or may not be performed based on the result of human detection process 402. For example, speech analysis process may be performed if no other persons are identified during human detection process 402. During speech analysis process 404, speaking by the user may be transcribed to obtain a transcription, and an assistance request outcome may be obtained. To transcribe the speaking by the user, audio data of the speaking may be converted (e.g., using speech-to-text applications) to a text format to obtain the transcription.

To obtain the assistance request outcome, large language model 408 may be prompted using the transcription and intention analysis prompt 406. For example, intention analysis prompt 406 may be provided as an input to large language model 408. Intention analysis prompt 406 may include any number and/or type of information regarding a request to analyze the transcription of the portion of the speaking to identify an intended target of the speaking. For example, intention analysis prompt 406 may include a text file that describes a context of the request (e.g., for purposes of user intent), a list of criteria to identify, an expected output format, and/or any other information.

Large language model 408 may include any number and/or type of information regarding a language based inference model. Large language model 408 may be hosted by data processing system 114 and/or any remote entities (e.g., service platforms 204). Large language model 408 may include, for example, parameters (e.g., weights, neural network layers, etc.) based on training data and/or provided by a large language model framework.

Transcription 412 may include any number and/or type of information regarding a text format of speaking by the user. For example, transcription 412 may include text of a portion of the speaking, information regarding qualities (e.g., tones) of the speaking, and/or any other information. Once obtained, transcription 412 may be used to identify whether the speaking includes a question and/or command directed to display free body wearable computing device 50.

Large language model 408 may generate a result based on intention analysis prompt 406 and the transcription during speech analysis process 404. The result may include assistance request outcome 410. Assistance request outcome 410 may include any number and/or type of information regarding an inference that indicates that display free body wearable computing device 50 is being queried by the user for assistance. For example, assistance request outcome 410 may infer that the speaking includes a question and/or command directed by the user to display free body wearable computing device 50.

To provide computer-implemented services based on the question and/or command, artificial intelligence assisting process 414 may be performed. Artificial intelligence assisting process 414 (shown in long-dashed lines) may or may not be performed based on assistance request outcome 410. For example, artificial intelligence assisting process 414 may be performed if assistance request outcome indicates that the speaking by the user includes a question and/or command directed to display free body wearable computing device 50.

During artificial intelligence assisting process 414, additional information may be obtained regarding the question and/or command, and an action set may be performed to provide computer-implemented services to the user. To obtain the additional information, display free body wearable computing device 50 may identify whether the question and/or command refers to at least one object present in a field of view of the user by analyzing transcription 412. For example, if the user issues a question (e.g., “What type of dog is this?) that may refer to a dog in a field of view of the user, camera 110 of display free body wearable computing device 50 may capture an image of the portion of the scene (e.g., including the dog) present in the field of view of the user. To perform the action set, the image and/or the question and/or command identified based on transcription 412 may be used to re-prompt large language model 408 to obtain an answer to the question and/or information usable to perform the command. For example, returning to the example in which the user issues the question (e.g., “What type of dog is this?”), display free body wearable computing device 50 may obtain a text formatted answer from large language model 408, convert the text formatted answer to a speech format, and communicate the speech formatted answer (e.g., “This dog is a Labrador retriever.”) to the user using speakers of display free body wearable computing device 50.

Thus, using the data flow shown in FIG. 4, assistance may be provided to a user using display free body wearable computing device 50 by inferring a user intended request based on speaking by the user.

Any of the components illustrated in FIGS. 1A-2 may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone array to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing assistance to users of display free body wearable computing devices, the method comprising:
identifying, using a first sensor of a display free body wearable computing device of the display free body wearable computing devices, that a user of the display free body wearable computing device is speaking;
based on the identifying:
inferring, using at least a second sensor of the display free body wearable computing device, whether at least one other person is in a detection range of the first sensor;
in a first instance of the inferring where no other persons are inferred as being in the detection range of the first sensor:
obtaining an assistance request outcome based on a transcription of the speaking by the user, an intention analysis prompt, and a large language model; and
a first instance of the obtaining where the assistance request outcome indicates that the speaking is directed to the display free body wearable computing device:
providing, by the display free body wearable computing device, computer-implemented services that are based, at least in part, on the transcription.

2. The method of claim 1, wherein identifying that the user of the display free body wearable computing device is speaking comprises:
obtaining audio data using the first sensor, the first sensor being an audio sensor positioned to capture the speaking; and
identifying that the audio data comprises the speaking by the user.

3. The method of claim 1, wherein inferring whether the at least one other person is in the detection range of the first sensor comprises:
identifying, using at least one image sensor of the display free body wearable computing device, whether the at least one other person is present in a field of view of the at least one image sensor; and
identifying, using at least two audio sensors of the display free body wearable computing device, whether the at least one other person is present within a distance threshold relative to the user.

4. The method of claim 3, wherein the at least two audio sensors comprise at least one audio sensor adapted to capture audio data from a direction behind the user's back while the user wears the display free body wearable computing device.

5. The method of claim 1, wherein obtaining the assistance request outcome comprises:
prompting, using the prompt, the large language model to identify, in the transcription, a user intended target of the speaking.

6. The method of claim 5, wherein prompting the large language model comprises:
inferring, using the large language model and the prompt, whether the speaking comprises a question and/or command directed by the user to the display free body wearable computing device,
wherein obtaining the assistance request outcome further comprises:
in a first instance of the inferring where the user intent comprises a question and/or command directed to the display free body wearable computing device:
generating the assistance request outcome to indicate that that the speaking indicates that the display free body wearable computing device is being queried by the user for assistance.

7. The method of claim 6, wherein providing the computer-implemented services comprises:
identifying whether the question and/or command refers to at least one object present in a field of view of the user;
in a first instance of the identifying where the question and/or command refers to the at least one object present in the field of view of the user:
capturing, using at least one image sensor of the display free body wearable computing device, an image of the at least one object; and
performing, by the display free body wearable computing device and using the image and the question and/or command, a first action set to provide the computer-implemented services;
in a second instance of the identifying where the question and/or command does not refer to the at least one object present in the field of view of the user:
performing, by the display free body wearable computing device and using the question and/or command, a second action set to provide the computer-implemented services.

8. The method of claim 7, wherein performing the first action set comprises:
re-prompting the large language model to obtain an answer to the question and/or information usable to perform the command.

9. The method of claim 1, further comprising:
in a second instance of the inferring where the at least one person is inferred as being in the detection range of the first sensor:
analyzing the speaking by the user using a schema, the schema comprising:
trigger phrases associated with corresponding functionalities of the display free body wearable computing device; and
in an instance of the analyzing where at least one of the trigger phrases are identified in the speaking:
performing a portion of the functionalities corresponding to the at least one of the trigger phrases to provide the computer-implemented services.

10. The method of claim 1, wherein the display free body wearable computing device comprises:
an integrated sensing and interaction component adapted to:
be positioned symmetrically on two portions of a user's head,
be positioned between ears and eyes of the user, and
capture a stereo image of at least a portion of a scene present in a field of view of the user;
an integrated computing, powering, and securing portion; and
an adjustment member adapted to position the integrated sensing and interaction component with respect to the integrated computing, powering, and securing portion.

11. The method of claim 10, wherein the integrated sensing and interaction component comprises:
a pair of cameras;
speakers;
a microphone array; and
a touch pad.

12. The method of claim 11, wherein the integrated sensing and interaction component is adapted to:
obtain the stereo image from the pair of cameras;
at least partially process the stereo image to obtain an image processing result;
identify an action to be performed based, at least in part, on the image processing result and a derived result from a remote entity, the derived result being based, at least in part, on the stereo image and/or the image processing result; and
use at least the speakers to perform the action.

13. The system of claim 10, wherein the integrated computing, powering, and securing portion comprises:
a data processing system;
a battery;
a microphone array; and
a curved headband.

14. The system of claim 13, wherein the integrated computing, powering, and securing portion is adapted to:
obtain an audio input from the integrated sensing and interaction component;
perform, by the data processing system, a speech recognition action set, based on the audio input, to obtain a speech recognition result;
obtain a portion of data from a remote entity, the data being based at least in part on the speech recognition result; and
use the portion of the data to assist in an interaction that the user is involved in.

15. A non-transitory machine-readable medium having instructions stored therein, which when executed by a processor, cause the processor to perform operations for providing assistance to users of display free body wearable computing devices, the operations method comprising:
identifying, using a first sensor of a display free body wearable computing device of the display free body wearable computing devices, that a user of the display free body wearable computing device is speaking;
based on the identifying:
inferring, using at least a second sensor of the display free body wearable computing device, whether at least one other person is in a detection range of the first sensor;
in a first instance of the inferring where no other persons are inferred as being in the detection range of the first sensor:
obtaining an assistance request outcome based on a transcription of the speaking by the user, an intention analysis prompt, and a large language model; and
a first instance of the obtaining where the assistance request outcome indicates that the speaking is directed to the display free body wearable computing device:
providing, by the display free body wearable computing device, computer-implemented services that are based, at least in part, on the transcription.

16. The non-transitory machine-readable medium of claim 15, wherein identifying that the user of the display free body wearable computing device is speaking comprises:
obtaining audio data using the first sensor, the first sensor being an audio sensor positioned to capture the speaking; and
identifying that the audio data comprises the speaking by the user.

17. The non-transitory machine-readable medium of claim 15, wherein inferring whether the at least one other person is in the detection range of the first sensor comprises:
identifying, using at least one image sensor of the display free body wearable computing device, whether the at least one other person is present in a field of view of the at least one image sensor; and
identifying, using at least two audio sensors of the display free body wearable computing device, whether the at least one other person is present within a distance threshold relative to the user.

18. A data processing system, comprising:
a processor;
and a memory coupled to the processor to store instructions, which when executed by the processor, cause the processor to perform operations for providing assistance to users of display free body wearable computing devices, the operations comprising:
identifying, using a first sensor of a display free body wearable computing device of the display free body wearable computing devices, that a user of the display free body wearable computing device is speaking;
based on the identifying:
inferring, using at least a second sensor of the display free body wearable computing device, whether at least one other person is in a detection range of the first sensor;
in a first instance of the inferring where no other persons are inferred as being in the detection range of the first sensor:
obtaining an assistance request outcome based on a transcription of the speaking by the user, an intention analysis prompt, and a large language model; and
in a first instance of the obtaining where the assistance request outcome indicates that the speaking is directed to the display free body wearable computing device:
providing, by the display free body wearable computing device, computer-implemented services that are based, at least in part, on the transcription.

19. The data processing system of claim 18, identifying that the user of the display free body wearable computing device is speaking comprises:
obtaining audio data using the first sensor, the first sensor being an audio sensor positioned to capture the speaking; and
identifying that the audio data comprises the speaking by the user.

20. The data processing system of claim 18, wherein inferring whether the at least one other person is in the detection range of the first sensor comprises:
identifying, using at least one image sensor of the display free body wearable computing device, whether the at least one other person is present in a field of view of the at least one image sensor; and
identifying, using at least two audio sensors of the display free body wearable computing device, whether the at least one other person is present within a distance threshold relative to the user.
